(19) United States
(12) Patent Application Publication
(10) Pub. No.: US 2009/0323574 A1
(43) Pub. Date: Dec. 31, 2009

(54) SYSTEM AND METHOD FOR PROVIDING EFFICIENT CONTROL TRANSMISSION FOR SINGLE FREQUENCY NETWORK-BASED BROADCASTING OR MULTICASTING

(75) Inventors: Henri Markus Koskinen, Espoo (FI); Tommi Tapani Koivisto, Espoo (FI); Tatikonda Sivakumar, Tokyo (JP)

Correspondence Address: FOLEY & LARDNER LLP, P.O. BOX 80278, SAN DIEGO, CA, 92138-0278, US

(73) Assignee: Nokia Corporation

(21) Appl. No.: 12/111,124

(22) Filed: Apr. 28, 2008

Related U.S. Application Data
(60) Provisional application No. 60/914,486, filed on Apr. 27, 2007.
(60) Provisional application No. 60/983,517, filed on Oct. 29, 2007.

(51) Int. Cl. H04H 20/71

(52) U.S. Cl. 370/312

(57) ABSTRACT

A system and method for providing efficient control transmission for single frequency network-based broadcasting and/or multicasting. Various parameters that are needed to decode local single frequency network transmissions are signaled in a channel that is separate from the overlay single frequency network control channel. In various embodiments, this channel is transmitted at the level of a local single frequency network or at an individual cell level. This allows this channel to provide, at any given geographical location, the parameters that are used in the transmission of the particular local single frequency networks in that location.

### FIELD OF THE INVENTION

The present invention relates generally to Multimedia Broadcast/Multicast Services (MBMS). More particularly, the present invention relates to the signaling and processing of information in an MBMS Single Frequency Network (SFN) environment.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The 3^{rd} Generation Partnership Project (3GPP) is currently defining MBMS for the simultaneous delivery of multimedia content to a large set of receivers. A set of MBMS specifications will be published by 3GPP, covering all aspects of the service from the radio access to the content delivery applications and protocols. As part of 3G long term evolution (LTE), MBMS is being standardized for the purpose of supporting efficient broadcast services such as, for example, mobile TV services.

LTE MBMS currently supports two transmission modes-a single-cell, point-to-multipoint transmission mode and a MBMS over a single frequency network (MBSFN) transmission mode. In MBSFN, each base station usually transmits the same content in a synchronized manner That is, a terminal receives transmissions from different cells as virtual multipath components, which can provide a gain in terms of received signal power, thus improving the coverage (as compared to sending the content separately in each cell (unsynchronized)). Operating in this manner, MBSFN enables a highly efficient method of broadcasting, as the transmissions from different base stations reinforce each other instead of causing interference to each other.

MBMS can support both wide area transmission (to support for example, national TV channels) as well as more localized transmissions (to support local content, e.g., local news). In order to inform a terminal about physical layer and bearer parameters of the transmissions, session identities, indications of session starts, discontinuous reception (DRX) information and other related control information, a related control channel is embedded in both wide and local area transmissions. In order to decode the control channels, a terminal typically needs to have knowledge about the physical layer parameters used for the transmission of those channels.

Also the control signaling is most efficiently delivered as an MBSFN transmission. This is because, in such an arrangement, the coverage of the control channel is not limited by cell edge areas, as MBSFN provides a sufficient signal to interference-plus-noise ratio (SINR) gain. Therefore, the capacity of the control channels, when delivered as MBSFN transmissions, may be significantly larger than when using single-cell transmission.

### SUMMARY OF THE INVENTION

Various embodiments provide an improved system and method for providing efficient control information transmission for single frequency network-based broadcasting and/or multicasting. According to various embodiments, a control channel transmitted over an overlay MBSFN area signals the time-frequency resources and possibly other parameters of a local MBSFN control channel. The physical layer-related parameters that are needed to decode the local MBSFN area control information/data transmissions from the given location including, for example, used reference signal sequences and scrambling codes, are signaled in an additional control channel that is separate from the overlay MBSFN control channel. In various embodiments, the channel may be transmitted at the level of a local MBSFN or even at an individual cell level. For example, primary control information may be MBSFN-transmitted over an entire synchronization area over known radio resources (or over the area corresponding to the largest possible SFN area). Secondary control information, specific to a certain local MBSFN, is then carried over the corresponding MBSFN area. Typically, the MBSFN-transmission can be performed using, e.g., fixed modulation and coding schemes/techniques. Thus, terminals can read primary control information after synchronization and initial access (e.g., the terminal is able to decode a primary part first without additional knowledge). This exemplary arrangement allows the channel to provide, at any given geographical location, the exact parameters that are used in the transmission of the particular local MBSFNs in that location. Those parameters, together with the information transmitted with the overlay MBSFN control information, allow for the unambiguous reception of all of the MBSFN transmissions that are available in any given location. Such a system and method enables efficient control channel arrangements where the control information requiring most capacity may be MBSFN-transmitted, thus consuming fewer radio resources and being more efficient from a spectrum usage point of view.

In accordance with various embodiments, methods, computer program products, and apparatuses are provided for processing a first set of signaling information for use in a single frequency network, the first set of signaling information being received on a first control channel over a wide area single frequency network. Additionally, a second set of signaling information for use together with the first set of signaling information is processed, where the second set of signaling information is being received on a second control channel separate from the first control channel. Furthermore, the second set of signaling information is used in accessing localized single frequency network transmissions.

In accordance with other various embodiments, transmitting to a user equipment a first set of signaling information for use in a single frequency network is performed, where the first set of signaling information is transmitted on a first control channel over a wide area single frequency network. Additionally, transmitting to the user equipment a second set of signaling information for use together with the first set of signaling information is performed, where the second set of signaling information being transmitted on a second control channel separate from the first control channel. The second set of signaling information is usable by the user equipment in accessing single frequency network transmissions.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the invention are described by referring to the attached drawings, in which:

FIG. 1, is an exemplary representation of local and wide areas associated with an exemplary overlay-type control channel arrangement in a single frequency network;

FIG. 2 is a graphical representation showing how a P-MCCH carried over an overlay MBSFN points to individual S-MCCHs, the contents of which depend upon the location of the user equipment;

FIGS. 3(a)-3(d) are representations of a communication system and various architectures capable of performing signaling according to various embodiments;

FIGS. 4 and 5 are flow charts showing processes performed for providing control information.

FIG. 6 is a flow chart showing the implementation of an exemplary use scenario with a shared carrier according to various embodiments, where one control channel (P-MCCH) is transmitted over an overlay MBSFN, while another control channel (D-BCH) is single-cell-transmitted;

FIG. 7 is a flow chart showing the implementation of another exemplary use scenario with a shared carrier according to various embodiments, where a S-MCCH is transmitted over an overlay MBSFN and P-MCCH is used to indicate which local MBSFN areas are available in current cell;

FIG. 8 is a diagram of hardware that can be used to implement an embodiment of the invention;

FIGS. 9A and 9B are diagrams of different cellular mobile phone systems capable of supporting various embodiments of the invention;

FIG. 10 is a perspective view of an electronic device that can be used in conjunction with the implementation of various embodiments of the present invention;

FIG. 11 is a schematic representation of the circuitry which may be included in the electronic device of FIG. 10;

FIG. 12 is a diagram of exemplary components of a mobile station capable of operating in the systems of FIGS. 9A and 9B, according to an embodiment of the invention; and

FIG. 13 is a diagram of an enterprise network capable of supporting the processes described herein, according to an embodiment of the invention.

### DETAILED DESCRIPTION OF VARIOUS EMBODIMENTS

According to various embodiments, SFN operation for MBMS is provided, in which macro diversity gain is obtained by transmitting the same signals from all of the base stations belonging to the SFN area. That is, for multicell reception in a terminal that receives the signal from an SFN, the same bits are transmitted from all of the base stations belonging to the SFN in a synchronized manner. In operation, signals from several base stations are combined in a terminal receiver, as is similarly done in, e.g., the case of multipath components originating from the same base station.

Additionally, due to the gain obtained from SFN, the control channel is transmitted as a SFN transmission (as opposed to transmitting it as single-cell transmissions separately in each cell). With the gain obtained from SFN, higher order modulation and coding schemes/techniques can be utilized, or sites can be deployed with a larger inter-site distance.

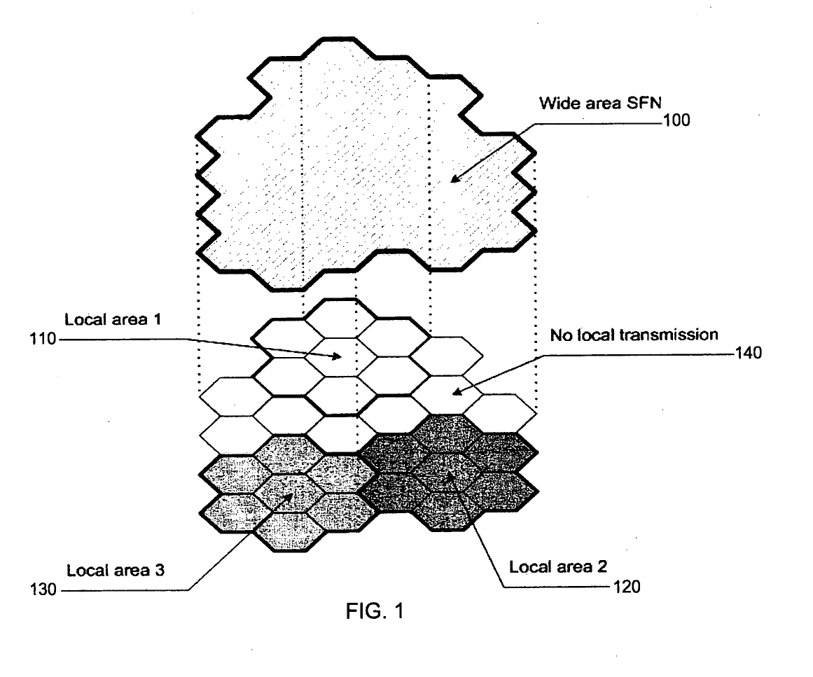

As described above, actual traffic channels can be SFN-transmitted. Hence, if the control channels are not SFN-transmitted, the coverage of traffic channels may not match with that of the control channels. For example, in the E-UTRAN MBMS context, extending coverage by SFN transmission is possible in a dedicated carrier MBMS deployment where the carrier radio resources are not shared with unicast transmissions. Hence, in this case, the coverage does not necessarily need to be designed according to single-cell transmission. Furthermore, in a network with both wide area and local area SFN transmissions, such as the network illustrated in FIG. 1 and described in greater detail below, each SFN area has a separate control signalling, as the actual content can differ as well. As such, the terminal requires knowledge about which control channels are available in the given geographical area where the terminal is located.

According to an exemplary control channel arrangement, the primary control information may be MBSFN-transmitted over an entire synchronization area over known radio resources (or over the area corresponding to the largest possible SFN area). Additionally, the MBSFN-transmission can be performed using, e.g., fixed modulation and coding schemes/techniques. The terminals can read primary control information after synchronization and initial access (e.g., the terminal is able to decode a primary part first without additional knowledge). For example, primary control information may be MBSFN-transmitted over an “overlay” MBSFN, with the overlay MBSFN covering all of the other MBSFN areas. Secondary control information, specific to a certain local MBSFN, is then carried over the corresponding MBSFN area. This arrangement is depicted in FIG. 1, where a wide area SFN 100 is overlayed over a first local area 110, a second local area 120, a third local area 130, and a fourth local area 140, with the fourth local area 140 not receiving any local transmissions. The wide area SFN 100 and the local areas 110, 120, 130, and 140 are capable of transmitting different localized content on, e.g., another set of radio resources that is non-overlapping with the wide area SFN radio resources. The exemplary arrangement depicted in FIG. 1 can, according to various embodiments, possess an architecture that is compliant with, e.g., the Universal Mobile Telecommunication System (UMTS) Terrestrial Radio Access Network (UTRAN) LTE (Evolved UTRAN or E-UTRAN).

In the LTE MBMS context, the control channel carried in the overlay MBSFN area in the above exemplary arrangement is the primary MBMS control channel (P-MCCH), while the lower layer control channels are secondary MBMS control channels (S-MCCHs). Although various embodiments described herein are explained in relation to a 3GPP LTE architecture, various embodiments have applicability to any type of communication system having, e.g., equivalent functional capabilities. For example, a S-MCCH may be analogous to a secondary control channel and a P-MCCH may be analogous to a primary control channel in another system.

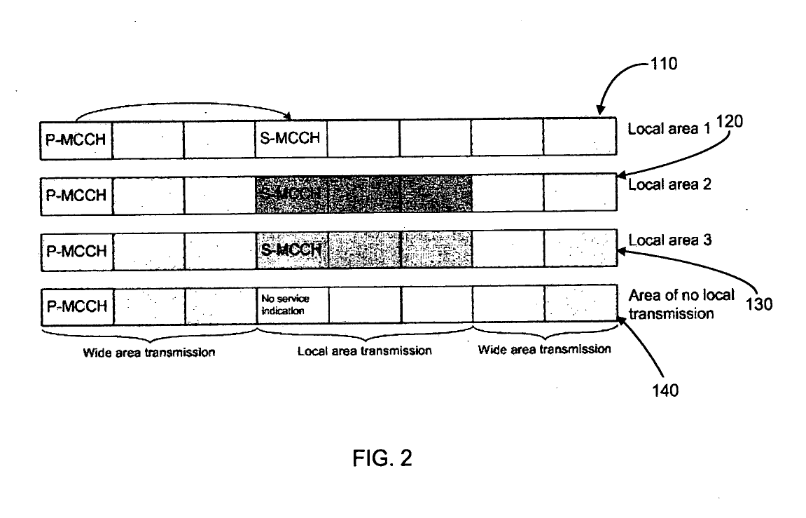

In the control channel arrangement described above, there is no interference on the P-MCCH from other MBSFN areas, thereby resulting in a high control channel capacity. In this arrangement, the P-MCCH carries scheduling information for each S-MCCH, and the contents of each individual S-MCCH varies with respect to the geographical location of the user. That is, the scheduling information provided in the P-MCCH is valid for each local area. This is graphically depicted in FIG. 2, for each of the first, second, third and fourth local areas 110, 120, 130 and 140, respectively. As shown in FIG. 2, the contents of the S-MCCH differs for the first, second and third local areas 110, 120 and 130, while the fourth local area 140 receives no local area transmission. However, all four of the local areas receive the same P-MCCH transmission. Additionally, control information for the MBSFN-transmission can be either embedded in the P-MCCH, or a pointer to the S-MCCH can be provided.

It should be noted that to also receive control for the local transmissions, a S-MCCH slot can be shared by the local transmissions. Thus, the S-MCCH for the local transmission can be located in the same scheduling unit in each local transmission area. However, the contents of the S-MCCH can be different in each local area. Furthermore, the underlying assumption regarding the localized transmissions is that there is no service continuity requirement between the SFN areas. If this assumption is not valid and in accordance with various embodiments, re-use of resources in time or frequency domain can be provided. For instance, a terminal may perform a search for the S-MCCH in all possible locations (e.g., for three resources, three locations are searched).

In an alternative arrangement, instead of having the P-MCCH carried over the overlay MBSFN, the P-MCCH is delivered as a single-cell transmission or more localized MBSFN transmission, and the S-MCCH is carried over the overlay MBSFN. In this arrangement, the S-MCCH provides scheduling and radio bearer information for all services that are provided within the S-MCCH's MBSFN area, i.e. both wide area and local area services. The geographical location of the user determines which services from those listed in S-MCCH are actually available to the user. This arrangement may provide for capacity gains, and terminals only have to monitor one S-MCCH, independent of the number of MBSFN areas that are available in a particular geographical area.

In the above approaches, the overlay MBSFN cannot carry any information that is needed to actually decode the local MBSFN transmissions. Typically, in order to reduce the effect of interference from other local MBSFN areas, each MBSFN area needs to use, e.g., a distinct set of reference signals and scrambling sequences (and possibly other similar physical layer parameters). This information is needed before a piece of user equipment can gain access to the respective local MBSFN area(s) via the overlay MBSFN. Therefore, without this information, the user equipment is incapable of decoding the local MBSFN transmissions.

Although the control channel arrangement described herein involves two layers of SFN areas (wide and local), such an arrangement can also be implemented in different deployments with two or more layers. These SFN area layers may or may not be hierarchically arranged, i.e. so that each SFN area in a lower layer is a “subset” of an SFN area at a higher layer. Various embodiments are not restricted to hierarchical deployments—if the deployment is not hierarchical, in one example embodiment, the P-MCCH can carry the scheduling information for the localized MBSFN S-MCCHs of each layer separately (each layer has its own S-MCCHs). In this case, the P-MCCH is carried over the largest possible SFN area.

In case there is reuse in time or frequency domain to cope with interference at the border of the local SFN areas, the P-MCCH can either include the scheduling information of all possible S-MCCH locations, or alternatively the terminal can determine the other possibilities from the scheduling of the first S-MCCH in a predetermined manner.

Various embodiments provide an improved system and method for providing efficient control transmission for single frequency network-based broadcasting and/or multicasting. According to various embodiments, physical layer-related parameters, that are needed to decode the local MBSFN transmissions including, for example, used reference signal sequences and scrambling codes, are signaled in a channel that is separate from the overlay MBSFN control channel. In various embodiments, the channel may be transmitted at the level of a local MBSFN or even at an individual cell level. This exemplary arrangement allows the channel to provide, at any given geographical location, the exact parameters that are used in the transmission of the particular local MBSFNs in that location. Those parameters, together with the information transmitted on the overlay MBSFN, allow for the unambiguous reception of all of the MBSFN transmissions that are available in any given location. Such a system and method enables efficient control channel arrangements where the control information requiring most capacity may be MBSFN-transmitted, thus consuming fewer radio resources and being more efficient from a spectrum usage point of view. It should be understood that, although examples are provided herein in terms of a MBSFN, various embodiments are applicable to other types of single frequency networks as well.

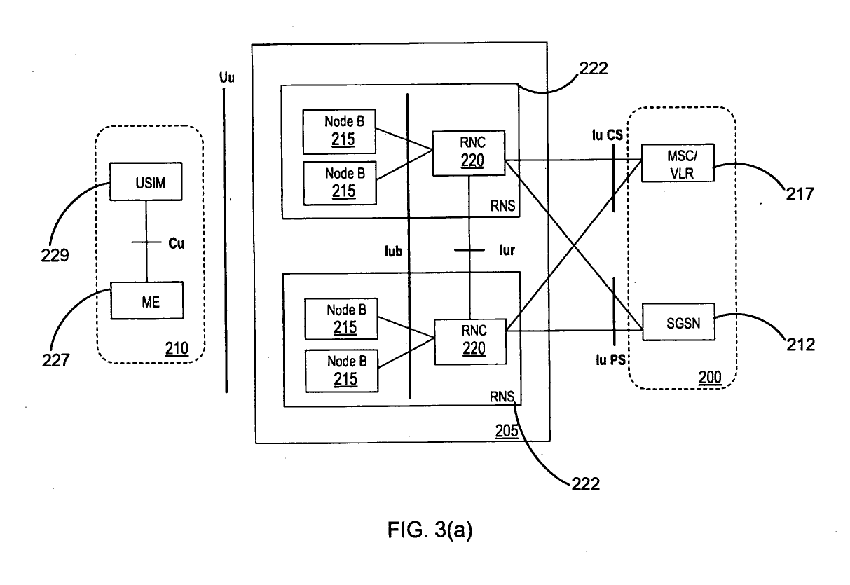

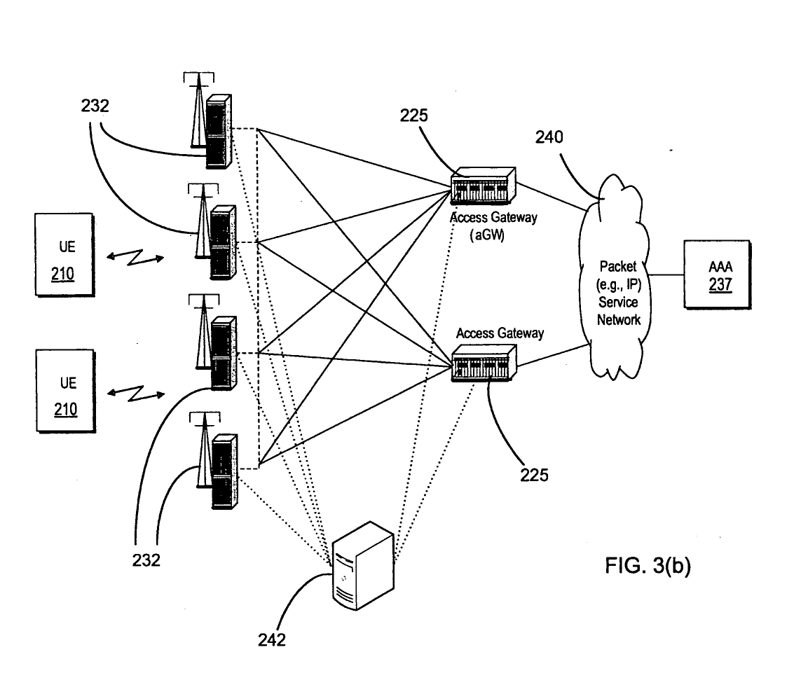

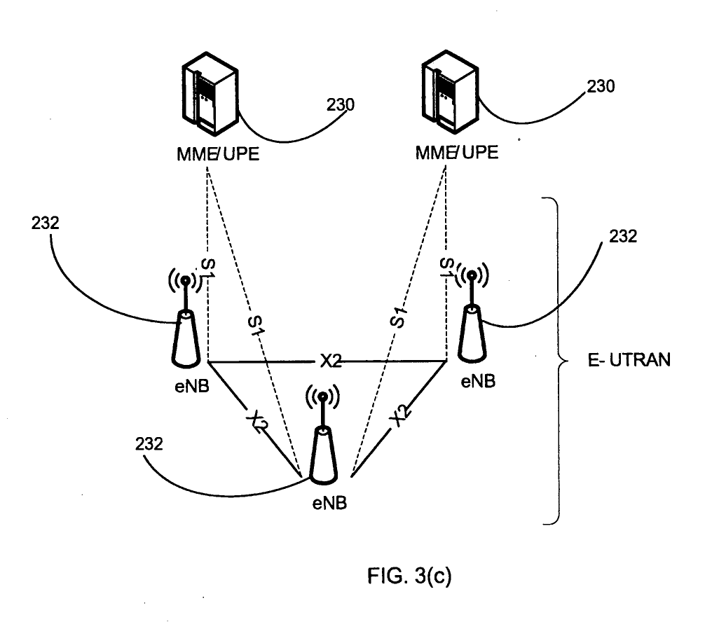

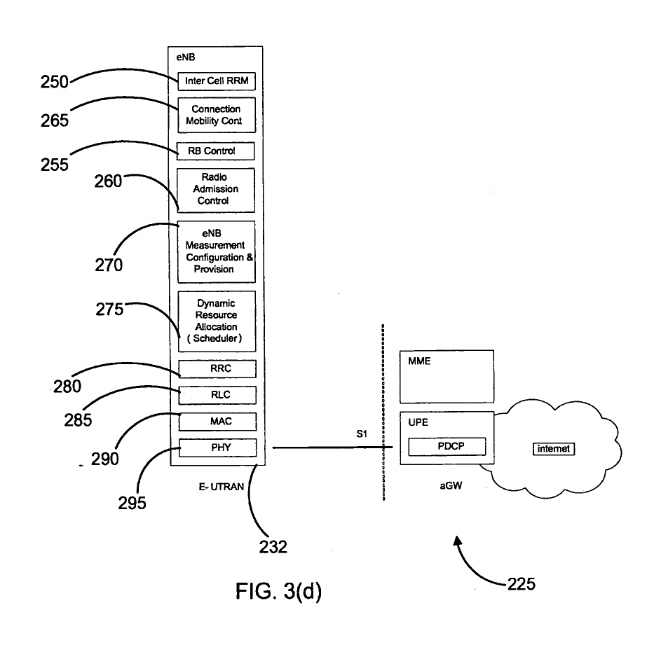

FIGS. 3(a)-3(d) are diagrams of a communication system and associated architectures capable of performing control signaling, according to various exemplary embodiments of the invention. A UMTS network (as in FIG. 3(a)) includes three interacting domains: a core network (CN) 200, a UMTS terrestrial radio access network (UTRAN) 205, and user equipment 210. The core network 200 can provide such functions as switching, routing and transit for user traffic and may include a serving GPRS support node (SGSN) 212 and a mobile services switching center/visitor location register (MSC/VLR) 217. The UTRAN 205 provides the air interface access method for the user equipment 210. The UTRAN 205 in FIG. 3(a) includes a plurality of radio network subsystems (RNSs) 222, each including nodes B 215 a radio network controller (RNC) 220. The user equipment 210 is depicted in FIG. 3(a) as including mobile equipment 227 associated with a universal subscriber identity module (USIM) 229.

The communication system includes one or more user equipment 210 that communicates with the node B 215, which includes radio frequency transmitter(s) and receiver(s) used to communicate directly with the mobile stations. The node B may utilize a Multiple Input Multiple Output (MIMO) antenna system. For example, the node B 215 may provide two antennas transmit and receive capabilities. This arrangement supports the parallel transmission of independent data streams to achieve high data rates. The node B 215 and the user equipment 210 may communicate using Wideband Code Division Multiple Access (WCDMA), Orthogonal Frequency Division Multiplexing (OFDM) or Single Carrier Frequency Division Multiple Access (FDMA) (SC-FDMA). In an exemplary embodiment, downlink utilizes OFDM.

Furthermore, the Radio Network comprising one or more node Bs 215, which may include the following components/functions, as depicted in FIG. 3(d): intercell radio resource management (RRM) 250; radio bearer (RB) control 255; radio admission control 260; connection mobility control 265; node B measurement, configuration and provision 270; dynamic resource allocation (scheduler) 275; RRC layer 280; radio link control (RLC) layer 285; media access control (MAC) layer 290; and physical layer device (PHY) layer 295. Additionally, the node B 215 can serve several cells, also called sectors, depending on the configuration and type of antenna.

Access gateways (aGWs) 225, as shown in FIG. 3(b), or Mobile Management Entity/User Plane Entities (MME/UPEs) 230, as shown in FIG. 3(c), are connected to evolved node Bs (eNBs) 232 in a full or partial mesh configuration using tunneling over a packet transport network (e.g., IP network). Exemplary functions of the aGWs 225 include distribution of paging messages to the eNBs 232, IP header compression, termination of U-plane packets for paging reasons, and switching of U-plane for support of user equipment mobility. Since the aGWs 225 serve as a gateway to external packet service networks 240, e.g., the Internet or private consumer networks, the aGWs 225 include an access, authorization and accounting system (AAA) 237 to securely determine the identity and privileges of a user and to track each user's activities. A multicell coordination entity (MCE) 242 may interact with the eNBs 232 and the aGWs 225 in order to coordinate MBSFN transmissions. More particularly, the MCE 242 is used to allocate radio resources used by the eNBs 232 in the MBSFN area for multi-cell MBMS transmissions using MBSFN operations. This may also include setting up the control channels and allocating radio resources to them.

In terms of gaining access to MBMS services, each piece of user equipment gains access through a chain of control channels. In the LTE MBMS context, this chain starts with a primary broadcast channel (P-BCH), and then progressively goes through a dynamic BCH (D-BCH), P-MCCH(s), and then S-MCCH(s). The P-BCH is transmitted on known radio resources and contains D-BCH scheduling information. The D-BCH contains P-MCCH scheduling information, and a P-MCCH includes S-MCCH scheduling information. As discussed above and according to various embodiments, the information that is needed by a piece of user equipment to decode individual MBSFN areas under an overlay MBSFN is placed in a channel separate from the channel that is delivered over the overlay MBSFN.

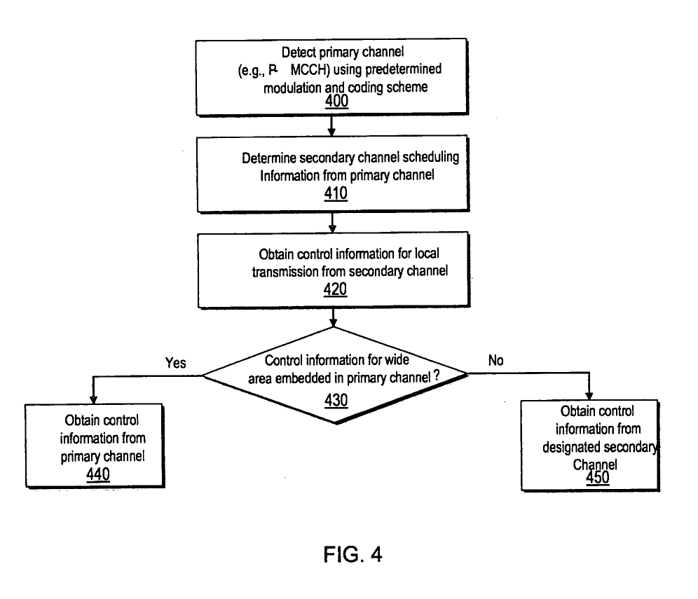

FIG. 4 is a flow chart showing various processes for providing control information which can be obtained by a terminal. At 400, the P-MCCH is detected and read from a known location, using a known modulation and coding scheme/technique. From P-MCCH, the S-MCCH scheduling information is determined at 410. The scheduling information, for example, can specify the time and frequency resources used for S-MCCH transmissions as well as other required information (e.g., the modulation and coding scheme that was used). At 420, the S-MCCH is read from the given scheduling unit to obtain the control information for the local transmissions. If there is no local transmission in that particular geographical area, a short indication about this may be transmitted by the cells. Alternatively, the terminal may just detect that there is no local transmission, because in that case the cells will be idle. As described above, the control information for the wide area transmission may be embedded in P-MCCH, or alternatively, a pointer to secondary MCCH of the wide area can be provided at 430. However, this S-MCCH is separated from the S-MCCH of the local area. If the control information is embedded in the P-MCCH, the control information is obtained therefrom at 440. If the control information is pointed to, the control information is obtained from the designated S-MCCH at 450.

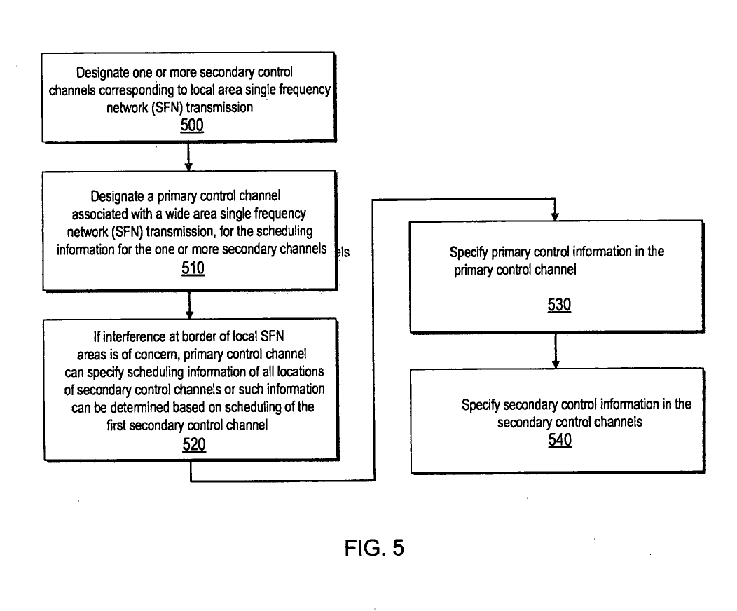

FIG. 5 shows a process for utilizing the control structure illustrated in, e.g., FIG. 3. For example, the process designates one or more secondary control channels to correspond to local area SFN transmissions at 500. In addition, a primary control channel is designated for a wide area SFN, in which scheduling information is specified for the one or more secondary channels at 510. That is, at 520, if interference at the border of local SFN areas is of concern, the P-MCCH can specify scheduling information of all locations of S-MCCHs or such information can be determined based on the scheduling of a first S-MCCH. Consequently, at 530 and 540, primary control information and secondary control information, respectively, can be specified in the respective control channels.

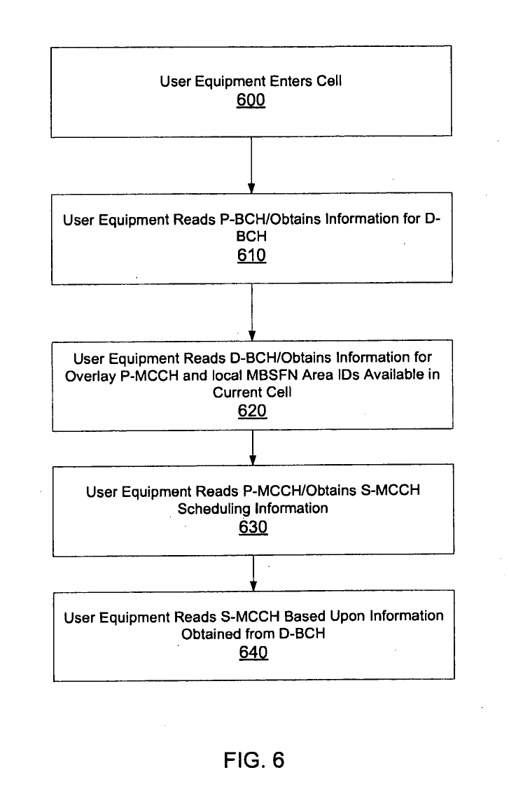

In a more detailed example of the processes illustrated in, e.g., FIG. 4, FIG. 6 is a flow chart showing the implementation of an exemplary use scenario with a shared carrier according to various embodiments. In this scenario, the P-BCH is single-cell-transmitted, as is the D-BCH. The P-MCCH is transmitted over an overlay MBSFN and information regarding which MBSFN areas are “under” the overlay MBSFN is included in the D-BCH. At 600 in FIG. 6, the user equipment enters the cell and, at 610, reads the D-BCH scheduling information on the P-BCH. Based on this information, at 620 the user equipment reads the D-BCH, thereby obtaining information for the overlay P-MCCH and local MBSFN area identifications (IDs) that are available in the current cell. Each MBSFN area ID may be one-to-one linked to the needed physical layer parameters such as reference signals and scrambling sequences. At 630, the user equipment reads the P-MCCH, which contains S-MCCH scheduling information. At 640, the user equipment reads the S-MCCH based upon information obtained from the D-BCH. Alternatively, the D-BCH may simply contain the parameters that are needed to decode local MBSFN transmissions in the cell. In this case, the parameters are read by the user equipment, and the user equipment uses the parameters to perform the decoding.

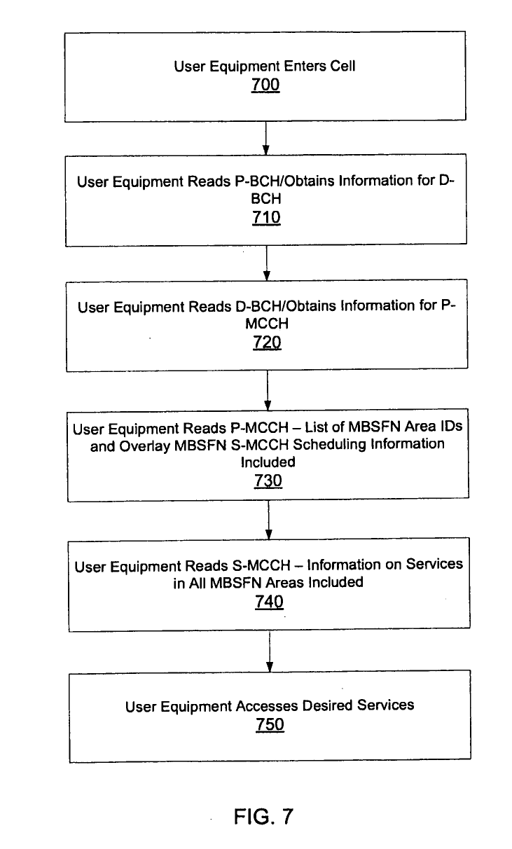

In accordance with another more detailed example of the processes illustrated in, e.g., FIG. 4, FIG. 7 is a flow chart showing the implementation of another exemplary use scenario with a shared carrier according to various embodiments. In this scenario, a P-MCCH is single-cell-transmitted, and the S-MCCH is transmitted over the overlay MBSFN. At 700 in FIG. 7, the user equipment enters a cell. At 710, the user equipment reads the D-BCH scheduling information on the P-BCH. Based on this information, at 720 the user equipment reads the D-BCH, thereby obtaining the scheduling information for the P-MCCH. In this scenario, the P-MCCH contains a list of MBSFN area IDs that are available in the cell within which the user equipment resides, as well as the scheduling information of the overlay MBSFN S-MCCH. This information is read by the user equipment at 730. The S-MCCH, in turn, contains information on services in all MBSFN areas that exist “under” the overlay MBSFN, indexed by MBSFN area ID. The MBSFN area ID may be one-to-one linked to the physical layer parameters such as reference signals and scrambling sequences. Because the user equipment knows which MBSFN areas exist in the current cell based on what it read from the P-MCCH, it has all of the knowledge necessary to gain access to MBMS services. The user equipment therefore reads the information on the S-MCCH at 740 and accesses the desired service(s) at 750.

According to various embodiments, at least one channel is transmitted over the lowest layer, in addition to the control channel over the overlay MBSFN. The “lowest layer” may comprise either a single cell or a local MBSFN area.

In accordance with one method, designating one or more secondary control channels corresponding to local area single frequency network (SFN) transmissions is performed. Additionally, a primary control channel, associated with a wide area SFN transmission, is designated for scheduling information of the one or more secondary control channels. Furthermore, the one method comprises specifying primary control information in the primary control channel and specifying secondary control information in the one or more secondary control channels.

According to one aspect of the exemplary embodiment, the primary control channel and the one or more secondary channels provide information necessary to receive a MBMS service. Moreover, in accordance with various embodiments, the primary control channel and the one or more secondary channels are structured hierarchically. It should be noted that the secondary channels can correspond to a plurality of local area configurations.

According to another aspect of various embodiments, reuse of transmission resources is provided to address interference at the border of local SFN areas. The primary control channel includes the scheduling information of all possible locations of the secondary control channels. Alternatively, other possible locations can be determined based on scheduling of a first one of the secondary control channels.

According to yet another aspect of various embodiments, SFN transmissions are effectuated according to a 3GPP architecture. Additionally, various embodiments may be implemented in a system including a first network element configured to designate one or more secondary control channels corresponding to local area single frequency network (SFN) transmissions. The system may also include a network element configured to designate a primary control channel, associated with a wide area SFN transmission, for scheduling information of the one or more secondary control channels. The primary control information is specified in the primary control channel. Secondary control information is specified in the one or more secondary control channels. In accordance with various embodiments, the first network element includes a MCE.

In accordance with another exemplary embodiment, a method comprises detecting a primary channel using a predetermined modulation and coding scheme. The method also comprises determining scheduling information for a secondary channel. The method further comprises obtaining control information for local transmission from the secondary channel.

According to another exemplary embodiment, an apparatus comprises logic configured to detect a primary channel using a predetermined modulation and coding scheme. The logic is further configured to determine scheduling information for a secondary channel and to obtain control information for local transmission from the secondary channel. According to one aspect of this exemplary embodiment, the apparatus is a handset. The apparatus further comprises a transceiver.

According to another exemplary embodiment, an apparatus comprises means for detecting a primary channel using a predetermined modulation and coding scheme. The apparatus also comprises means for determining scheduling information for a secondary channel. The apparatus further comprises means for obtaining control information for local transmission from the secondary channel.

Communication devices of the various embodiments discussed herein may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

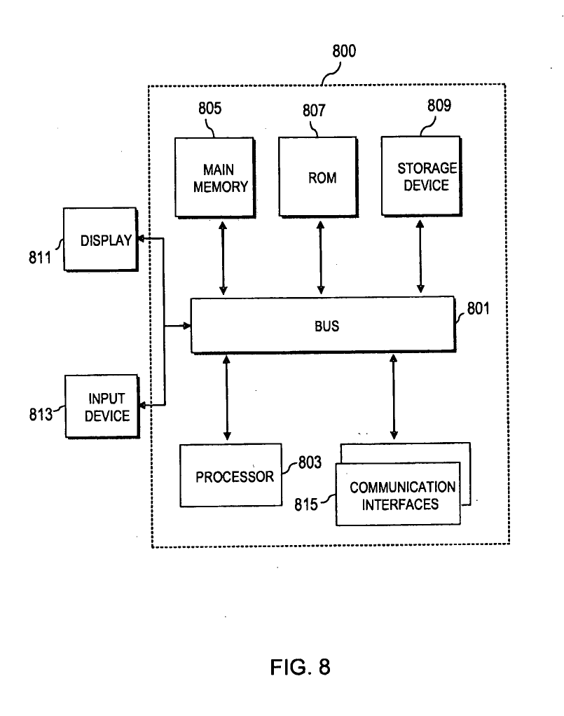

FIG. 8 illustrates additional exemplary hardware upon which various embodiments of the invention can be implemented. A computing system 800 includes a bus 801 or other communication mechanism for communicating information and a processor 803 coupled to the bus 801 for processing information. The computing system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computing system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computing system 800 may be coupled via the bus 801 to a display 811, such as a liquid crystal display, or active matrix display, for displaying information to a user. An input device 813, such as a keyboard including alphanumeric and other keys, may be coupled to the bus 801 for communicating information and command selections to the processor 803. The input device 813 can include a cursor control, such as a mouse, a trackball, or cursor direction keys, for communicating direction information and command selections to the processor 803 and for controlling cursor movement on the display 811.

According to various embodiments of the invention, the processes described herein can be provided by the computing system 800 in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 800 also includes at least one communication interface 815 coupled to bus 801. The communication interface 815 provides a two-way data communication coupling to a network link (not shown). The communication interface 815 sends and receives electrical, electromagnetic, or optical signals that carry digital data streams representing various types of information. Further, the communication interface 815 can include peripheral interface devices, such as a Universal Serial Bus (USB) interface, a PCMCIA (Personal Computer Memory Card International Association) interface, etc.

The processor 803 may execute the transmitted code while being received and/or store the code in the storage device 809, or other non-volatile storage for later execution. In this manner, the computing system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

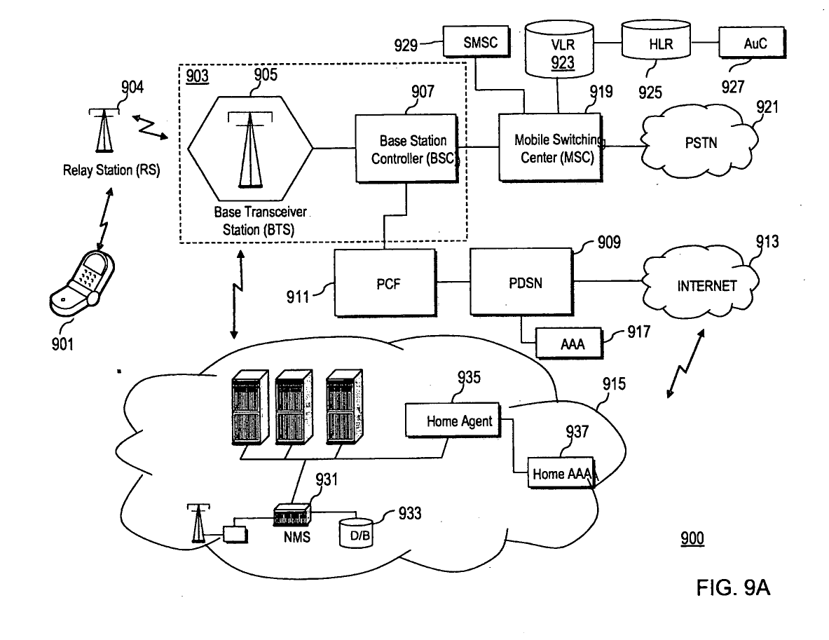

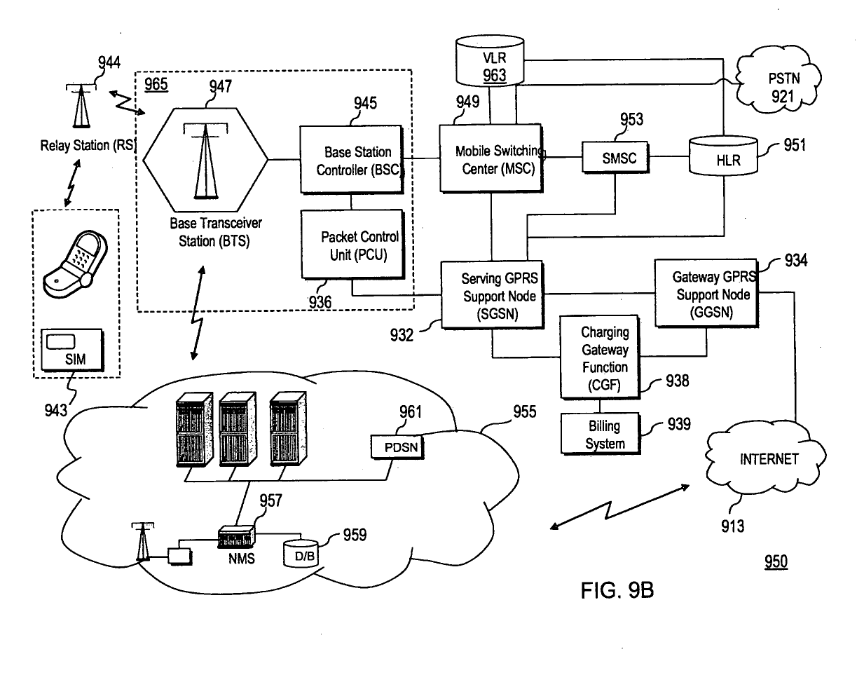

FIGS. 9A and 9B are diagrams of different cellular mobile phone systems capable of supporting various embodiments of the invention. FIGS. 9A and 9B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 900 includes mobile stations 901 (e.g., handsets, terminals, stations, units, devices, or any type of interface to the user (such as “wearable” circuitry, etc.)) in communication with a Base Station Subsystem (BSS) 903 through a relay station (RS) 904. According to one embodiment of the invention, the radio network supports Third Generation (3G) services as defined by the International Telecommunications Union (ITU) for International Mobile Telecommunications 2000 (IMT-2000).

In this example, the BSS 903 includes a Base Transceiver Station (BTS) 905 and Base Station Controller (BSC) 907. Although a single BTS is shown, it is recognized that multiple BTSs are typically connected to the BSC through, for example, point-to-point links. Each BSS 903 is linked to a Packet Data Serving Node (PDSN) 909 through a transmission control entity, or a Packet Control Function (PCF) 911. Since the PDSN 909 serves as a gateway to external networks, e.g., the Internet 913 or other private consumer networks 915, the PDSN 909 can include an Access, Authorization and Accounting system (AAA) 917 to securely determine the identity and privileges of a user and to track each user's activities. The network 915 comprises a Network Management System (NMS) 931 linked to one or more databases 933 that are accessed through a Home Agent (HA) 935 secured by a Home AAA 937.

Although a single BSS 903 is shown, it is recognized that multiple BSSs 903 are typically connected to a Mobile Switching Center (MSC) 919. The MSC 919 provides connectivity to a circuit-switched telephone network, such as the Public Switched Telephone Network (PSTN) 921. Similarly, it is also recognized that the MSC 919 may be connected to other MSCs 919 on the same network 900 and/or to other radio networks. The MSC 919 is generally collocated with a Visitor Location Register (VLR) 923 database that holds temporary information about active subscribers to that MSC 919. The data within the VLR 923 database is to a large extent a copy of the Home Location Register (HLR) 925 database, which stores detailed subscriber service subscription information. In some implementations, the HLR 925 and VLR 923 are the same physical database; however, the HLR 925 can be located at a remote location accessed through, for example, a Signaling System Number 7 (SS7) network. An Authentication Center (AuC) 927 containing subscriber-specific authentication data, such as a secret authentication key, is associated with the HLR 925 for authenticating users. Furthermore, the MSC 919 is connected to a Short Message Service Center (SMSC) 929 that stores and forwards short messages to and from the radio network 900.

During typical operation of the cellular telephone system, BTSs 905 receive and demodulate sets of reverse-link signals from sets of mobile units 901 conducting telephone calls or other communications. Each reverse-link signal received by a given BTS 905 is processed within that station. The resulting data is forwarded to the BSC 907. The BSC 907 provides call resource allocation and mobility management functionality including the orchestration of soft handoffs between BTSs 905. The BSC 907 also routes the received data to the MSC 919, which in turn provides additional routing and/or switching for interface with the PSTN 921. The MSC 919 is also responsible for call setup, call termination, management of inter-MSC handover and supplementary services, and collecting, charging and accounting information. Similarly, the radio network 900 sends forward-link messages. The PSTN 921 interfaces with the MSC 919. The MSC 919 additionally interfaces with the BSC 907, which in turn communicates with the BTSs 905, which modulate and transmit sets of forward-link signals to the sets of mobile units 901.

As shown in FIG. 9B, the two key elements of the General Packet Radio Service (GPRS) infrastructure 950 are the Serving GPRS Supporting Node (SGSN) 932 and the Gateway GPRS Support Node (GGSN) 934. In addition, the GPRS infrastructure includes a Packet Control Unit PCU (936) and a Charging Gateway Function (CGF) 938 linked to a Billing System 939. A GPRS the Mobile Station (MS) 941 employs a Subscriber Identity Module (SIM) 943. Under this scenario, a relay station (RS) 944 provides extended coverage for the MS 941.

The PCU 936 is a logical network element responsible for GPRS-related functions such as air interface access control, packet scheduling on the air interface, and packet assembly and re-assembly. Generally the PCU 936 is physically integrated with the BSC 945; however, it can be collocated with a BTS 947 or a SGSN 932. The SGSN 932 provides equivalent functions as the MSC 949 including mobility management, security, and access control functions but in the packet-switched domain. Furthermore, the SGSN 932 has connectivity with the PCU 936 through, for example, a Frame Relay-based interface using the BSS GPRS protocol (BSSGP). Although only one SGSN is shown, it is recognized that that multiple SGSNs 931 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 945, any given BSC 945 generally interfaces with one SGSN 932. Also, the SGSN 932 is optionally connected with the HLR 951 through an SS7-based interface using GPRS enhanced Mobile Application Part (MAP) or with the MSC 949 through an SS7-based interface using Signaling Connection Control Part (SCCP). The SGSN/HLR interface allows the SGSN 932 to provide location updates to the HLR 951 and to retrieve GPRS-related subscription information within the SGSN service area. The SGSN/MSC interface enables coordination between circuit-switched services and packet data services such as paging a subscriber for a voice call. Finally, the SGSN 932 interfaces with a SMSC 953 to enable short messaging functionality over the network 950.

The GGSN 934 is the gateway to external packet data networks, such as the Internet 913 or other private customer networks 955. The network 955 comprises a Network Management System (NMS) 957 linked to one or more databases 959 accessed through a PDSN 961. The GGSN 934 assigns Internet Protocol (IP) addresses and can also authenticate users acting as a Remote Authentication Dial-In User Service host. Firewalls located at the GGSN 934 also perform a firewall function to restrict unauthorized traffic. Although only one GGSN 934 is shown, it is recognized that a given SGSN 932 may interface with one or more GGSNs 933 to allow user data to be tunneled between the two entities as well as to and from the network 950. When external data networks initialize sessions over the GPRS network 950, the GGSN 934 queries the HLR 951 for the SGSN 932 currently serving a MS 941.

The BTS 947 and BSC 945 manage the radio interface, including controlling which Mobile Station (MS) 941 has access to the radio channel at what time. These elements essentially relay messages between the MS 941 and SGSN 932. The SGSN 932 manages communications with an MS 941, sending and receiving data and keeping track of its location. The SGSN 932 also registers the MS 941, authenticates the MS 941, and encrypts data sent to the MS 941.

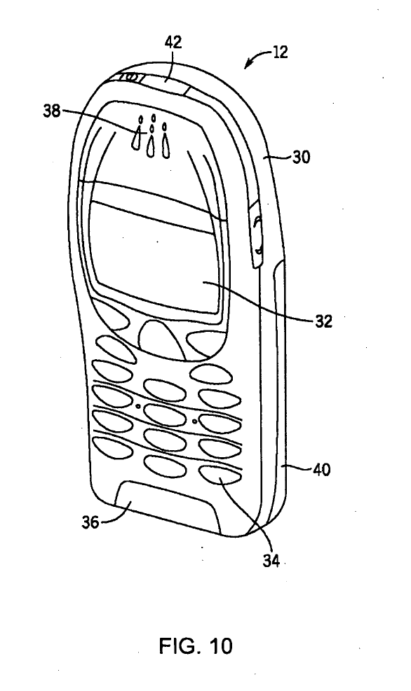

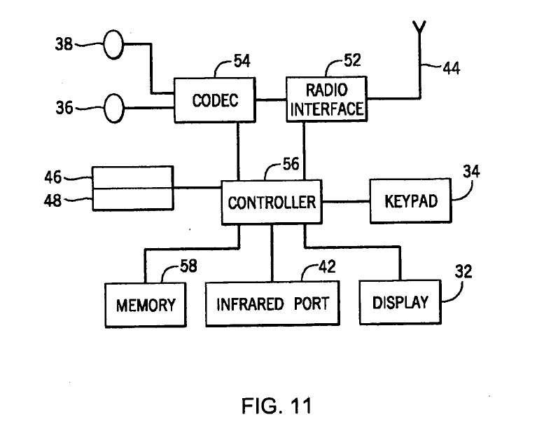

FIGS. 10 and 11 show one representative electronic device 12 within which various embodiments may be implemented. Any and all of the devices described herein may include any and/or all of the features described in FIGS. 10 and 11. It should be understood, however, that various embodiments are not intended to be limited to one particular type of electronic device. The electronic device 12 of FIGS. 10 and 11 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

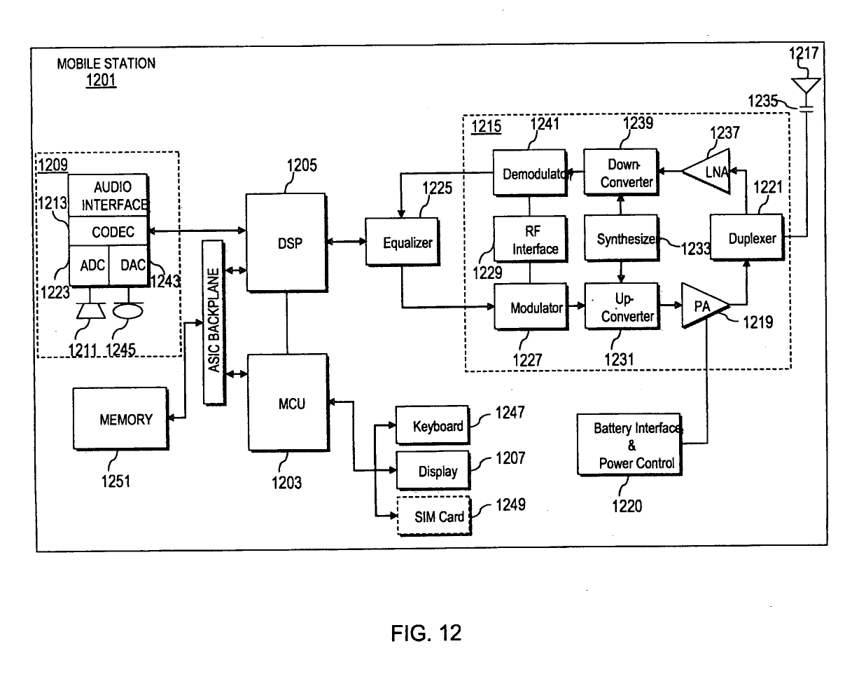

FIG. 12 is a diagram of exemplary components of a mobile station (e.g., handset) capable of operating in the systems of FIGS. 9A and 9B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system (e.g., systems of FIG. 6A or 6B), via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The MCU 1203 delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

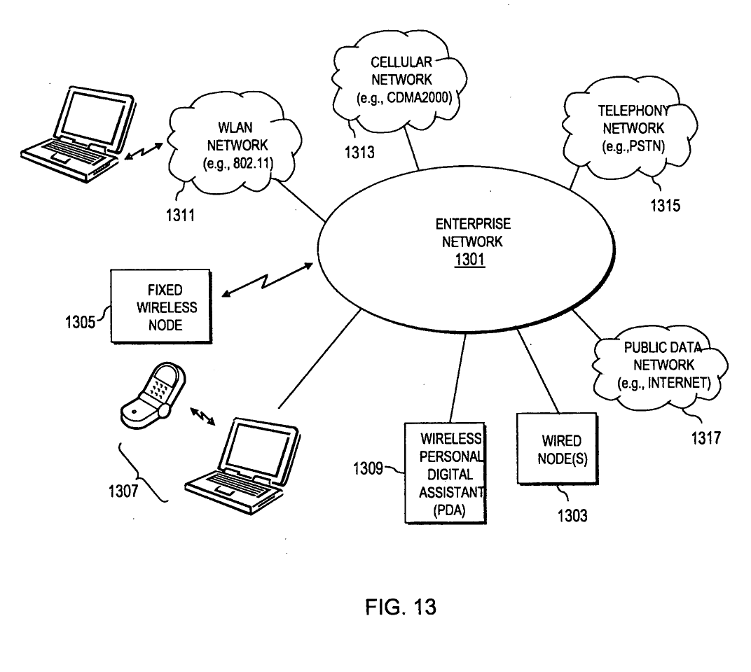

FIG. 13 shows an exemplary enterprise network, which can be any type of data communication network utilizing packet-based and/or cell-based technologies (e.g., Asynchronous Transfer Mode (ATM), Ethernet, IP-based, etc.). The enterprise network 1301 provides connectivity for wired nodes 1303 as well as wireless nodes 1305-1309 (fixed or mobile), which are each configured to perform the processes described above. The enterprise network 1301 can communicate with a variety of other networks, such as a WLAN network 1311 (e.g., IEEE 802.11), a cdma2000 cellular network 1313, a telephony network 1315 (e.g., PSTN), or a public data network 1317 (e.g., Internet).

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

Various embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
processing a first set of signaling information for use in a single frequency network, the first set of signaling information being received on a first control channel over a wide area single frequency network; and
processing a second set of signaling information for use in relation with the first set of signaling information, the second set of signaling information being received on a second control channel separate from the first control channel; and
using the second set of signaling information in accessing single frequency network transmissions.

2. The method of claim 1, wherein the first control channel is received over an overlay wide area single frequency network.

3. The method of claim 2, wherein the second set of signaling information is received over an area smaller than the wide area overlay single frequency network.

4. The method of claim 1, wherein the second set of signaling information comprises physical layer parameters.

5. The method of claim 1, wherein the first control channel comprises a primary multimedia broadcast/multicast service (MBMS) control channel (P-MCCH), and wherein the second control channel comprises a dynamic broadcast channel.

6. The method of claim 5, wherein the dynamic broadcast channel includes at least one parameter needed for decoding at least one single frequency network transmission within a current cell.

7. The method of claim 1, wherein the first control channel comprises a secondary multimedia broadcast/multicast service (MBMS) control channel (S-MCCH), and wherein the second control channel comprises a primary MBMS control channel (P-MCCH).

8. The method of claim 7, wherein the P-MCCH includes at least one single frequency network area identification associated with a current cell and scheduling information for the S-MCCH.

9. The method of claim 8, wherein the S-MCCH includes information regarding services in at least one single frequency network area that exist under the overlay single frequency network, indexed by single frequency network area identification.

10. The method of claim 1, further comprising determining scheduling information from the first control channel.

11. The method of claim 1, further comprising obtaining local transmission control information from the second control channel.

12. The method of claim 1, further comprising obtaining wide area control information, wherein the wide area control information is one of embedded in the first control channel and pointed to in the secondary control channel from the first control channel.

13. A computer program product, embodied in a computer-readable medium, comprising computer code configured to perform the processes of claim 1.

14. An apparatus, comprising:
a processor; and
a memory unit communicatively connected to the processor and including:
computer code configured to process a first set of signaling information for use in a single frequency network, the first set of signaling information being received on a first control channel over a wide area single frequency network;
computer code configured to process a second set of signaling information for use in relation with the first set of signaling information, the second set of signaling information being received on a second control channel separate from the first control channel; and
computer code configured to use the second set of signaling information in accessing single frequency network transmissions.

15. The apparatus of claim 14, wherein the first control channel is received over an overlay wide area single frequency network.

16. The apparatus of claim 14, wherein the second set of signaling information is received over an area smaller than the wide area overlay single frequency network.

17. The apparatus of claim 14, wherein the second set of signaling information comprises physical later parameters.

18. The apparatus of claim 14, wherein the first control channel comprises a primary multimedia broadcast/multicast service (MBMS) control channel (P-MCCH), and wherein the second control channel comprises a dynamic broadcast channel.

19. The apparatus of claim 18, wherein the dynamic broadcast channel includes at least one parameter needed for decoding at least one single frequency network transmission within a current cell.

20. The apparatus of claim 14, wherein the first control channel comprises a secondary multimedia broadcast/multicast service (MBMS) control channel (S-MCCH), and wherein the second control channel comprises a primary MBMS control channel (P-MCCH).

21. The apparatus of claim 20, wherein the P-MCCH includes at least one single frequency network area identification associated with a current cell and scheduling information for the S-MCCH.

22. The apparatus of claim 21, wherein the S-MCCH includes information regarding services in at least one single frequency network area that exist under the overlay single frequency network, indexed by single frequency network area identification.

23. The apparatus of claim 14, wherein the memory unit further comprises computer code configured to determine scheduling information from the first control channel.

24. The apparatus of claim 14, wherein the memory unit further comprises computer code configured to obtain local transmission control information from the second control channel.

25. The apparatus of claim 14, wherein the memory unit further comprises computer code configured to obtain wide area control information, wherein the wide area control information is one of embedded in the first control channel and pointed to in the secondary control channel from the first control channel.

26. A method, comprising:
transmitting to a user equipment a first set of signaling information for use in a single frequency network, the first set of signaling information transmitted on a first control channel over a wide area single frequency network; and
transmitting to the user equipment a second set of signaling information for use in relation with the first set of signaling information, the second set of signaling information being transmitted on a second control channel separate from the first control channel,
wherein the second set of signaling information is usable by the user equipment in accessing single frequency network transmissions.

27. The method of claim 26, wherein the first control channel is transmitted over an overlay wide area single frequency network.

28. The method of claim 26, wherein the second set of signaling information is transmitted over an area smaller than the wide area overlay single frequency network.

29. The method of claim 26, wherein the second set of signaling information comprises physical layer parameters.

30. The method of claim 26, wherein the first control channel comprises a primary multimedia broadcast/multicast service (MBMS) control channel (P-MCCH), and wherein the second control channel comprises a dynamic broadcast channel.

31. The method of claim 30, wherein the dynamic broadcast channel includes at least one parameter needed for decoding at least one single frequency network transmission within a current cell.

32. The method of claim 26, wherein the first control channel comprises a secondary multimedia broadcast/multicast service (MBMS) control channel (S-MCCH), and wherein the second control channel comprises a primary MBMS control channel (P-MCCH).

33. The method of claim 32, wherein the P-MCCH includes at least one single frequency network area identification associated with a current cell and scheduling information for the S-MCCH.

34. The method of claim 33, wherein the S-MCCH includes information regarding services in at least one single frequency network area that exist under the overlay single frequency network, indexed by single frequency network area identification.

35. The method of claim 26, further comprising designating the first control channel for scheduling information for the secondary control channel.

36. The method of claim 26, further comprising designating the secondary control channel for local area single frequency network transmission.

37. A computer program product, embodied in a computer-readable medium, comprising computer code configured to perform the processes of claim 26.

38. An apparatus, comprising:
a processor; and
a memory unit communicatively connected to the processor and including:
computer code configured to transmit to a user equipment a first set of signaling information for use in a single frequency network, the first set of signaling information transmitted on a first control channel over a wide area single frequency network; and
computer code configured to transmit to the user equipment a second set of signaling information for use in relation with the first set of signaling information, the second set of signaling information being transmitted on a second control channel separate from the first control channel,
wherein the second set of signaling information is usable by the user equipment in accessing single frequency network transmissions.

39. The apparatus of claim 38, wherein the memory unit further comprises computer code configured to transmit the first control channel over an overlay wide area single frequency network.

40. The apparatus of claim 38, wherein the second set of signaling information is transmitted over an area smaller than the wide area overlay single frequency network.

41. The apparatus of claim 38, wherein the second set of signaling information comprises physical layer parameters.

42. The apparatus of claim 38, wherein the first control channel comprises a primary multimedia broadcast/multicast service (MBMS) control channel (P-MCCH), and wherein the second control channel comprises a dynamic broadcast channel.

43. The apparatus of claim 42, wherein the dynamic broadcast channel includes at least one parameter needed for decoding at least one single frequency network transmission within a current cell.

44. The apparatus of claim 38, wherein the first control channel comprises a secondary multimedia broadcast/multicast service (MBMS) control channel (S-MCCH), and wherein the second control channel comprises a primary MBMS control channel (P-MCCH).

45. The apparatus of claim 44, wherein the P-MCCH includes at least one single frequency network area identification associated with a current cell and scheduling information for the S-MCCH.

46. The apparatus of claim 45, wherein the S-MCCH includes information regarding services in at least one single frequency network area that exist under the overlay single frequency network, indexed by single frequency network area identification.

47. The apparatus of claim 38, wherein the memory unit further comprises computer code configured to designate the first control channel for scheduling information for the secondary control channel.

48. The apparatus of claim 38, wherein the memory unit further comprises computer code configured to designate the secondary control channel for local area single frequency network transmission.
